(19) United States
(12) Patent Application Publication
(10) Pub. No.: US 2024/0190273 A1
(43) Pub. Date: Jun. 13, 2024

(54) METHOD FOR CONDUCTING A PRE-CHARGING PROCESS OF AN ONBOARD ELECTRICAL SYSTEM OF A VEHICLE, AND ONBOARD ELECTRICAL SYSTEM FOR A VEHICLE

(71) Applicants: Mercedes-Benz Group AG, Stuttgart (DE); Vitesco Technologies GmbH, Regensburg (DE)

(72) Inventors: Urs BOEHME, Ehningen (DE); Franz PFEILSCHIFTER, Regensburg (DE); Juergen BENECKE, Ludwigsburg (DE); Markus ORNER, Renningen (DE); Nathan TRÖSTER, Stuttgart (DE)

(21) Appl. No.: 18/555,183

(22) PCT Filed: Apr. 13, 2022
(86) PCT No.: PCT/EP2022/059838

§ 371 Date: Oct. 12, 2023

(30) Foreign Application Priority Data
Apr. 15, 2021 (DE) 10 2021 109 443.7

(51) Int. Cl. B60L 53/22; B60L 53/16; H02J 7/00; H02J 7/34

(52) U.S. Cl. CPC B60L 53/22; B60L 53/16; H02J 7/007182; H02J 7/345; B60L 2240/547; H02J 2207/20

(57) ABSTRACT

A method is disclosed for conducting a pre-charging process of an onboard electrical system of a vehicle and for a charging process of a vehicle battery of the vehicle. The charging process immediately follows the pre-charging process. The vehicle battery is galvanically connected to a first onboard electrical sub-system of the onboard electrical system by a first switch element and a changeover switch and is galvanically separated from a charging path of the onboard electrical system by a second switch element. A line capacitor in the charging path is pre-charged to a first voltage value by a power source electrically connected to the charging path. A capacitor in the first onboard electrical sub-system is pre-charged to a second voltage value by the vehicle battery, wherein the vehicle battery is charged by the power source on the basis of the respective state of charge of the line capacitor and the capacitor.

### FIELD

The invention relates to a method for performing a pre-charging process of an onboard electrical system of a vehicle with a charging process of a vehicle battery of the vehicle immediately following the pre-charging process. Furthermore, the invention relates to an onboard electrical system for a vehicle with a first onboard electrical sub-system for electric components of the vehicle different from an electric drive unit, a second onboard electrical sub-system for the electric drive unit of the vehicle, a third onboard electrical sub-system for a vehicle battery of the vehicle, and a charging terminal for connecting the onboard electrical system to a power source external to vehicle.

### BACKGROUND

For example, DE 10 2019 008 835 A1 discloses a vehicle with a high-voltage onboard electrical system. Therein, the high-voltage onboard electrical system is divided into two partial areas, wherein the first partial area is arranged in a first installation space of the vehicle and the second partial area is arranged in at least one second installation space of the vehicle, wherein the division of the high-voltage onboard electrical system into the two partial areas is formed such that only operations under electrical voltage of the first partial area of the high-voltage onboard electrical system are possible in the first installation space of the vehicle and operations in a voltage-free state of the second partial area of the high-voltage onboard electrical system are possible in the at least one second installation space of the vehicle.

DE 10 2019 008 824 A1 discloses an onboard electrical system for a vehicle. The onboard electrical system comprises two potential lines, which are galvanically connectable or connected to a vehicle battery. In particular, the onboard electrical system is divided into three onboard electrical sub-systems.

### SUMMARY

The object of the present invention is to improve an electric charging process of a vehicle battery of a vehicle.

This object is solved by a method and an onboard electrical system according to the independent claims. Meaningful developments are apparent from the dependent claims.

An aspect of the invention relates to a method for performing a pre-charging process of an onboard electrical system of a vehicle for a charging process of a vehicle battery of the vehicle immediately following the pre-charging process, characterized in that the vehicle battery is galvanically connected to a first onboard electrical sub-system of the onboard electrical system by means of a first switch element and a changeover switch physically separated from the switch element and galvanically separated from a charging path of the onboard electrical system by means of a second switch element physically separated from the first switch element and from the changeover switch, and wherein the first onboard electrical sub-system is galvanically separated from the charging path by means of the changeover switch, at least one line capacitance of the charging path of the onboard electrical system is pre-charged to a first voltage value by a power source electrically connected to the charging path, at least one capacitor of the first onboard electrical sub-system is pre-charged to a second voltage value by the vehicle battery, wherein the vehicle battery of the vehicle is charged by the power source depending on a respective state of charge of the at least one line capacitance of the charging path and of the at least one capacitor of the first onboard electrical sub-system.

With the aid of the method according to the invention, an onboard electrical system, in particular high-voltage onboard electrical system, of the vehicle can in particular be pre-charged in efficient, safe and more loss-free manner. By pre-charging, the onboard electrical system of the vehicle can in particular be brought to a preset voltage level for the imminent charging process of the vehicle battery. Thus, negative characteristics of charging the vehicle battery without pre-charging process can be prevented. Thus, the lifetime of the onboard electrical system and of the components contained therein can in particular be considerably increased. With the aid of the proposed method, it can in particular be achieved that upon a direct current charging process of the vehicle battery, DC charging warnings can be complied with. This is in particular effected by pre-charging the charging path by means of the power source.

In particular, the pre-charging process or pre-charging of the onboard electrical system is affected in time immediately before performing the charging process of the vehicle battery. In particular, the vehicle battery of the vehicle is charged only when the pre-charging process has been completed.

In particular, the driving mode and the charging mode of the vehicle exclude each other to the effect that the components respectively not required are galvanically separated from the remaining onboard electrical system. Thus, these separated components no longer contribute to the overall capacitance of the onboard electrical system by their Y-capacitances. Accordingly, large Y-capacitances can therefore be installed in the components without exceeding the allowable limit value. This in particular allows complying with safety requirements with respect to the energy content of the Y-capacitances and the EMC requirements.

In order to be able to achieve this, in the electric charging mode of the vehicle battery, at least the drive onboard electrical system can be separated with respect to the units to be charged. By the onboard electrical system according to the invention, providing multiple battery outputs for each individual onboard electrical sub-system can be omitted. Similarly, by the division of the mutually physically separated switches of the onboard electrical system according to the invention, over-dimensioned, cost-intensive and error-prone changeover switches as in the prior art can be omitted. By omitting multiple battery outputs, an expensive protection of each of these outputs can be omitted, whereby a cost reduction can be performed, and safety-critical flaws can be minimized.

The vehicle, in particular motor vehicle, in particular road vehicle, is in particular formed as an electric vehicle or as a hybrid vehicle. In particular, the vehicle battery, in particular a high-voltage battery, can be electrically charged by connection of the vehicle, in particular the onboard electrical system thereof, in particular a high-voltage onboard electrical system, to at least one electrical energy source external to vehicle as the current charging source, in particular to a charging station.

In particular, the onboard electrical system can be a high-voltage onboard electrical system.

In particular, an electrical DC voltage, which is in particular greater than about 60 Volts, is to be understood by the term “high-voltage”. In particular, the term “high-voltage” is to be interpreted compliant with the standard ECE R 100.

The onboard electrical system can be divided into the first onboard electrical sub-system, a second onboard electrical sub-system and a third onboard electrical sub-system. In order that the vehicle and in particular the onboard electrical system can be supplied with an electrical voltage, the onboard electrical system can be electrically connected to the charging source or power source via the charging terminal thereof, in particular voltage terminals, such that the charging voltage, in particular a DC voltage, can be provided to the vehicle, in particular to the onboard electrical system.

The electric drive unit is in particular intended for driving the vehicle. Thus, the at least one electric drive unit is in particular a so-called electric traction machine of the vehicle. The onboard electrical system can for example also comprise multiple of such electric drive units, in particular a front electric drive unit, in particular for driving wheels of a front axle of the vehicle, and a rear electric drive unit, in particular for driving wheels of a rear axle of the vehicle.

The first onboard electrical sub-system comprises the electric components. The electric components can for example be electric accessories such as for example an electric refrigerant compressor or an electric heating element.

Electric components of the onboard electrical system usually possess Y-capacitors for establishing electromagnetic compatibility. Such Y-capacitors can also be provided on the side of the charging station, which is also in the area of the DC power source. The effect of Y-capacitors in the range of the electromagnetic compatibility, in particular of the radio interference suppression, is known to the expert, such that separate further explanations are not required in this respect. For the rest, reference is made to the relevant standardization, thus, for example the guideline 2014/30/EU, about the electromagnetic compatibility, DIN/EN 61000 and furthers.

For reasons of the electrical safety, an electrical energy stored in all of the Y-capacitors is not to exceed a presettable maximum value. Such a value is for example 0.2 J. This regularly results in a constructive design such that the capacitance values of the Y-capacitors are usually selected smaller on the side of the vehicle than they would be required for a proper establishment of the electromagnetic compatibility, in particular with respect to the electric components, which are connected to the onboard electrical system.

Among other things, it has turned out to be problematic if the vehicle is to be charged by means of an AC voltage from a charging station. In such a case, the overall capacitance provided on the side of the vehicle at Y-capacitors proves to be hindering because these Y-capacitors can also cause a leakage current, which can result in a malfunction initiation on the side of the charging station and/or overall can exceed an admissible value of the leakage currents in electrical equipments, as it is for example also specified in the standard, thus for example in the standard DIN EN 61800 or the like. Fundamentally, this problem can only be solved by reduction of the capacitance values of the Y-capacitors provided in the vehicle, but wherein it is to be considered that the expenditure of the filter units can be considerably increased thereby.

Moreover, it is required in particular in charging by means of a DC voltage, that an energy content of all of the effective Y-capacitors does not exceed a preset overall energy content. Hereto, a maximum value of 0.2 J is currently provided, which is not to be exceeded. By the plurality of the electric components of the vehicle and the increasing power, for example in high-voltage components, the overall capacitance of the present Y-capacitors becomes greater and greater, whereby the energy content stored there also increases corresponding to the increasing overall capacitance. Moreover, it is to be considered that the energy content of the Y-capacitors is particularly critical in particular in the range of high-voltage, particularly as it is to be considered that the electrical energy stored in the Y-capacitors is quadratically dependent on the electrical voltage of the Y-capacitors. Thereby, complying with the requirements concerning maximum energy content with respect to respective high-voltage potential becomes particularly difficult especially in the range of “high-voltage”. Especially in vehicles, it proves to be problematic to satisfy both requirements concerning the electromagnetic compatibility and requirements concerning the electrical safety with respect to the energy of the Y-capacitors at the same time.

The charging path is in particular a part of the onboard electrical system, by which the charging voltage of the external power source, in particular of the charging station, can be provided. With the aid of the charging path, put in other words, the charging voltage of the external power source can be transferred to very different components of the onboard electrical system. In particular, charging the vehicle battery is affected via the external power source only if a voltage level in the first onboard electrical sub-system and in the charging path has reached a preset or predefined voltage level or voltage condition. Thus, the charging process of the vehicle battery can be started without danger and without negative effects.

It is provided that for pre-charging the at least one capacitor of the first onboard electrical sub-system, a switch element of a semiconductor fuse, which is interconnected to at least one potential line between the first onboard electrical sub-system and the changeover switch, is opened, and for supplying the first onboard electrical sub-system with the charging voltage, the switch element of the semiconductor fuse is closed. In particular, the semiconductor fuse serves as a protective mechanism or protective measure for the onboard electrical system and in particular for the first onboard electrical sub-system. The semiconductor fuse, which contains semiconductor elements, can be interconnected to at least one of the two potential lines between the first onboard electrical sub-system and the changeover switch. Thus, the semiconductor fuse and the changeover switch can for example form a hybrid switching device.

With the aid of the semiconductor fuse, the changeover switch can in particular be switched load-free according to vehicle state. Thus, with the aid of the semiconductor fuse, the changeover switch can be employed more inexpensively and more optimized in installation space. In particular, the semiconductor fuse can have a blocking function, by which the load-free, loss-free switching of the changeover switch can be achieved. In particular, the semiconductor fuse can comprise semiconductor components. For example, a diode and the switch element are classed among them. For pre-charging the at least one capacitor of the first onboard electrical sub-system, the switch element parallel to the diode is opened such that the current path is disconnected in this branch.

For example, the semiconductor fuse can be a unidirectional or bidirectional fuse. With the aid of the semiconductor fuse, a line protection of the electric components of the first onboard electrical sub-system is in particular achieved.

If the pre-charging process is now completed, thus, the switch element of the semiconductor fuse can be closed such that this current path is again fully functional. In this state, the charging process of the vehicle battery can now be performed.

In an embodiment of the invention, it is provided that if the at least one, in particular parasitic, line capacitance of the charging path is charged to the first voltage value and the at least one capacitor of the first onboard electrical sub-system is charged to the second voltage value, the vehicle battery is galvanically connected to the charging path by means of the second switch element and galvanically separated from the first onboard electrical sub-system by means of the first switch element and the changeover switch, whereby the vehicle battery is charged by means of the power source. Put in other words, only if the capacitors or capacitances have reached the respectively preset voltage value, switching operations are performed, to correspondingly connect the vehicle battery to the power source. In a charging process of the vehicle battery by means of the switch elements and the changeover switch, a drive onboard electrical system, which comprises an electric drive unit of the vehicle, is in particular separated from the vehicle battery and the first onboard electrical sub-system.

For example, the capacitors can be Y-capacitors or intermediate circuit capacitors.

For example, the first and/or second switch element can be formed as separating elements, for example as all-pole contactors.

In a further embodiment, it is provided that the first onboard electrical sub-system is additionally galvanically connected to the charging path by means of the changeover switch, whereby the first onboard electrical sub-system is supplied by the power source, in particular at least one electric drive of the onboard electrical system is discharged immediately after the pre-charging process. After or parallel to the galvanic connection of the power source to the vehicle battery, the first onboard electrical sub-system is in particular connected to the charging path. Thus, the vehicle battery can be charged with the aid of the power source on the one hand and the electric component or accessories of the first onboard electrical sub-system can be electrically supplied parallel thereto by means of the power source.

For example, immediately after the vehicle battery has been connected to the power source and the first onboard electrical sub-system has been connected to the charging path, the at least one electric drive, in particular an onboard electrical sub-system of the electrical powertrain, can be discharged by means of a discharging circuit. Thus, the onboard electrical sub-system of the electric drive can in particular be voltage-free prepared. Only after the charging process has been completed and in particular a driving mode of the vehicle is to be performed, the electric drive can again be electrically connected to the vehicle battery and the first onboard electrical sub-system via the changeover switch and the switch elements.

In an embodiment, it is provided that a current flow from the changeover switch to the first onboard electrical sub-system is inhibited by the semiconductor fuse upon a short circuit within the onboard electrical system. Optionally, this can be performed by the switch element. Instead or additionally, the semiconductor fuse can comprise a diode. The diode is in particular a body diode of the semiconductor fuse. With the aid of the diode and/or the switch element, a reverse direction can be set. In particular, the diode is blocking if a short circuit arises within the onboard electrical system. If this case of a short circuit or another negatively connotated situation should occur, thus, the current flow can be interrupted. Thus, the components of the first onboard electrical sub-system can be protected from damage.

In a further embodiment of the invention, it is provided that the at least one capacitor of the first onboard electrical sub-system is pre-charged to the second voltage value by converting a battery voltage of the vehicle battery by means of a DC voltage converter of the first onboard electrical sub-system. For example, the first onboard electrical sub-system can have a lower voltage level with respect to the vehicle battery. Accordingly, the battery voltage can be converted for charging the capacitor of the first onboard electrical sub-system by means of the DC voltage converter. In particular, the DC voltage converter is a DC/DC converter. Thus, the battery voltage can be correspondingly adapted with the aid of the DC voltage converter such that an efficient charging process of the capacitor of the first onboard electrical sub-system can be performed. In particular, a voltage conversion of the charging voltage of the power source for supplying the electric components of the first onboard electrical sub-system can also be performed with the aid of the DC voltage converter in the charging process of the vehicle battery.

In a further embodiment of the invention, it is provided that the at least one line capacitance of the charging path and the at least one capacitor of the first onboard electrical sub-system are charged at the same time. Alternatively thereto, first the line capacitance of the charging path and subsequently the capacitor of the first onboard electrical sub-system can be charged. In order to be able to more efficiently and in particular faster perform the pre-charging of the onboard electrical system of the vehicle, it is advantageous if the two capacitors are charged at the same time, in particular parallel.

In an embodiment of the invention, it is provided that an insulating resistance of the onboard electrical system and/or of the direct current charging source is monitored by an insulation monitoring unit of the direct current charging source or by an insulation monitoring unit of the onboard electrical system during the pre-charging process of the onboard electrical system. The use of the insulation monitoring unit of the direct current charging source or of the onboard electrical system depends on the fact, with which charging standard or charging system the charging process of the vehicle is performed. Therein, it can for example be distinguished between a “Combined Charging System (CCS)”, a “CHAdeMO standard”, a type 2 plug system or a GB/T standard. Thus, according to the fact, by means of which charging plug system or charging system the vehicle is connected to the external charging station for the pre-charging process and the charging process, a corresponding possibility for monitoring the insulating resistances can be performed. In particular, this is automatically adapted according to which vehicle-side charging terminal the vehicle comprises and according to the type of the charging station.

In a further embodiment of the invention, it is provided that the first and/or second voltage value are adjusted depending on the battery voltage, in particular a voltage value of 800 Volts is provided by the battery voltage. In particular, the voltage values are adjusted depending on a preset target voltage. The target voltage for example conforms to the respective conditions of the vehicle. Therein, the vehicle battery, the onboard electrical system or the vehicle-side charging terminal can be taken into account. In particular, the two voltage values are adjusted or preset depending on the battery voltage of the vehicle battery. In particular, the vehicle battery is a battery with a voltage level of 800 Volts. Thus, the battery voltage has a voltage value of 800 Volts. In particular, the first voltage value can also have 800 Volts. In contrast, the second voltage value can have the voltage value of the vehicle battery minus a preset voltage difference. Therein, the second voltage value is for example set to 770, in particular 780 or to 790 Volts. Thus, the second voltage value has a preset voltage difference with respect to the first voltage value. This voltage difference is thereby advantageous since the semiconductor fuse can thereby be employed as a unidirectionally blocking fuse.

For example, the external power source can be a charging station with a charging voltage of 400 Volts, in particular 500 Volts. For charging the vehicle battery, this charging voltage can be correspondingly stepped up by an onboard charger.

A further aspect of the invention relates to an onboard electrical system for a vehicle with a first onboard electrical sub-system for electric components of the vehicle different from an electric drive unit, a second onboard electrical sub-system for the electric drive unit of the vehicle, a third onboard electrical sub-system for a vehicle battery of the vehicle, and a charging terminal for connecting the onboard electrical system to a power source external to vehicle, wherein the onboard electrical system is formed for performing a method according to any one of the preceding aspects.

In particular, a method according to any one of the previously described aspects or embodiments can be performed in the just described onboard electrical system.

Embodiments of individual aspects are to be regarded as advantageous embodiments of the other aspects and vice versa.

### BRIEF DESCRIPTION OF THE FIGURES

Further advantages, features and details of the invention are apparent from the following description of preferred embodiments as well as based on the drawing(s). The features and feature combinations mentioned above in the description as well as the features and feature combinations mentioned below in the description of figures and/or shown in the figures alone are usable not only in the respectively specified combination, but also in other combinations or alone without departing from the scope of the invention.

FIG. 1 is a schematic representation of a vehicle with an onboard electrical system.

FIG. 2 is a schematic embodiment of the onboard electrical system from FIG. 1.

FIG. 3 is a schematic flow diagram for pre-charging the onboard electrical system from FIG. 2.

In the figures, functionally identical elements are provided with the same reference characters.

### DETAILED DESCRIPTION

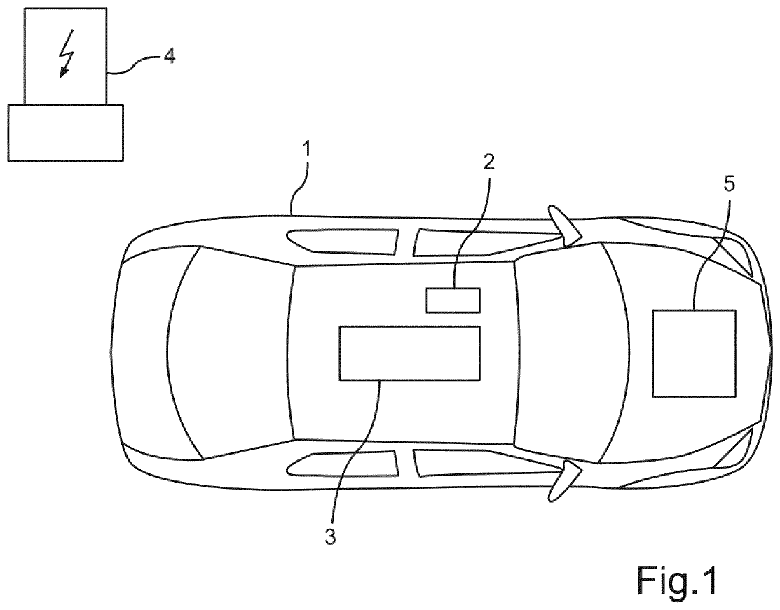

FIG. 1 shows a schematic representation of a vehicle 1. The vehicle 1, in particular motor vehicle, in particular road vehicle, is in particular formed as an electric vehicle or as a hybrid vehicle. In particular, a vehicle battery 2, in particular a high-voltage battery, can be electrically charged by connection of the vehicle 1, in particular of an onboard electrical system 3 of the vehicle, to at least one electrical energy source external to vehicle, in particular a power source 4. In particular, the power source 4 is a charging station or a charging device or a charging system. In particular, a charging process of the vehicle 1 by means of a direct current or an alternating current can be performed with the aid of the power source 4. The onboard electrical system can for example be a high-voltage onboard electrical system.

Furthermore, the vehicle 1 comprises at least one electric drive unit 5, which can be supplied with electrical energy by the vehicle battery 2, to be able to set the vehicle 1 in motion.

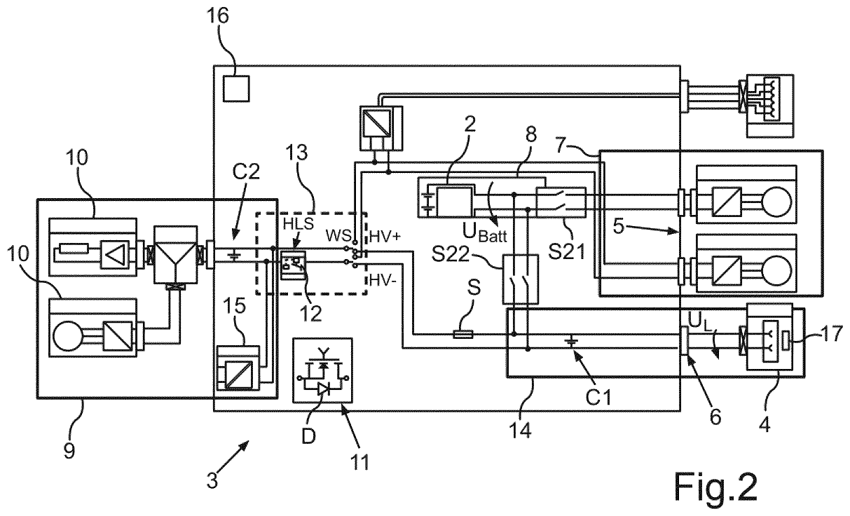

In FIG. 2, a schematic representation of the onboard electrical system 3 is illustrated. For example, the onboard electrical system 3 can comprise the vehicle battery 2, at least the one electric drive unit 5. Furthermore, the onboard electrical system comprises a charging terminal 6, by which the onboard electrical system 3 can be connected to the power source 4. In particular, the charging terminal 6 is a vehicle-side charging terminal of the vehicle 1. Furthermore, the at least one electric drive unit 5 can for example be a constituent of a second onboard electrical sub-system 7 of the onboard electrical system 3. The vehicle battery 2 can in turn be a constituent of a third onboard electrical sub-system 8. Furthermore, the onboard electrical system 3 can comprise a first onboard electrical sub-system 9. The first onboard electrical sub-system 9 can in particular comprise electric components 10 different from the electric drive unit 5. In particular, the electric components 10 are accessories of the vehicle 1. For example, the electric components 10 can be an electric refrigerant compressor unit, an electric heating unit, a heat pump or a DC voltage converter.

For example, the vehicle battery 2 can have a battery voltage U_{Batt} with a voltage value of for example 800 Volts DC. By the power source 4, a charging voltage U_{L} of for example 400 Volts, in particular 500 Volts DC, can for example be provided. Thus, for a charging process of the vehicle battery 2 by means of the power source 4, the charging voltage U_{L} has to be transformed up to the voltage level of the battery voltage U_{Batt} by means of an onboard charging unit or an onboard charger.

In order that the onboard electrical system 3 can be operated as efficiently as possible, for example a charging mode, in particular electric charging mode, for the vehicle battery 2 can be set in a first state of the onboard electrical system 3. For a second state of the onboard electrical system 3, the onboard electrical system 3 is set for a driving mode of the vehicle 1. For example, the onboard electrical system 3 comprises individual switch elements, by which either the state for charging the vehicle battery 2 or for the driving mode of the vehicle 1 can be set. For example, a changeover switch WS, a first switch element S21 and a second switch element S22 of the onboard electrical system 3 are arranged physically separated from each other. In particular, these three switch elements WS, S21, S22 are arranged or interconnected separated from or to each other within the onboard electrical system 3. For example, the first and the second switch element S21, S22 can each be formed as a contactor or as a semiconductor switch or as a relay.

For example, the first and the second switch element S21, S22 can be all-pole separating elements.

With the aid of the changeover switch WS, the first onboard electrical sub-system 9 can be galvanically connected either to the second onboard electrical sub-system 7 or to the DC voltage charging terminal 6. Thus, the changeover switch WS serves for alternatingly electrically coupling or electrically connecting the first onboard electrical sub-system 9 either to the first onboard electrical sub-system 9 or to the charging terminal 6 or a DC voltage charging terminal. Thus, with the aid of the changeover switch WS, the electric components 10 of the second onboard electrical sub-system 7 can be supplied with energy either by means of the vehicle battery 2 or by the power source 4.

In the following, it is now explained, which switch positions the onboard electrical system 3 has during an electric charging mode of the vehicle battery 2. For the electric charging mode of the vehicle battery 2, the charging terminal 6 can be galvanically connected to the third onboard electrical sub-system 8 by means of the first switch element S21. Thus, the second switch element S22 is closed in this case such that a direct electrical connection between the vehicle battery 2 and the external power source 4 is present. Furthermore, by means of the changeover switch WS, the charging terminal 6 can be galvanically connected to the first onboard electrical sub-system 9. Thus, the electric components 10 can be supplied by means of the charging voltage U_{L}. During the electric charging mode, the second onboard electrical sub-system 7 is galvanically separated from the third onboard electrical sub-system 8 by means of the first switch element S21 in this respect. In other words, the first switch element S21 is opened such that the electric drive unit 5 is in particular disconnected or separated from the vehicle battery 2.

Furthermore, by means of the changeover switch WS, the first onboard electrical sub-system 9 can be galvanically separated from the second onboard electrical sub-system 7. Thus, during the charging mode, the accessories of the accessory onboard electrical system, in particular of the first onboard electrical sub-system 9, are no longer supplied with energy by means of the vehicle battery 2 and/or the electric drive unit 5. Thus, during the electric charging mode of the vehicle battery 2, a direct electrical connection between the power source 4 and the vehicle battery 2 and the first onboard electrical sub-system 9 is present.

In particular, the components of the onboard electrical system 3 are electrically connected to each other by means of potential lines HV+, HV−. They are in particular electrical lines, in particular high-voltage lines, of the onboard electrical system 3.

In particular, for performing a safe charging process of the vehicle battery 2, an electrical fuse S can be interconnected between at least one potential line HV+ between the changeover switch WS and the charging terminal 6. It can for example be a safety fuse. It serves as a protective function for short circuits or for overcurrents.

In the following, the case is described, in which the vehicle 1 is in a driving mode. For the driving mode of the vehicle 1, the charging terminal 6 can be galvanically separated from the third onboard electrical sub-system 8 by means of the second switch element S22. Thus, the second switch element S22 is opened, such that an electrical connection is not present between the vehicle battery 2 and the power source 4. In addition, by means of the changeover switch WS, the charging terminal 6 can be galvanically separated from the first onboard electrical sub-system 9. Thus, the changeover switch WS is set to the voltage level of the battery voltage 2 in this case. In particular, for the driving mode of the vehicle 1, the second onboard electrical sub-system 7 is galvanically connected to the third onboard electrical sub-system 8 by means of the first switch element S21. Thus, the first switch element S21 is closed such that an electrical connection is present between the vehicle battery 2 and the at least one electric drive unit 5. Thus, the electric drive unit 5 can be supplied with electrical energy, in particular the battery voltage U_{Batt}, for an advancement drive of the vehicle 1. In addition, by means of the changeover switch WS, the first onboard electrical sub-system 9 can be galvanically connected to the second onboard electrical sub-system 7. Thus, during the driving mode of the vehicle 1, the electric components 10 of the first onboard electrical sub-system 9 can be supplied with electrical energy by the vehicle battery 2 and/or the electric drive unit 5.

In order that the changeover switch WS can be load-free alternatingly switched between the first onboard electrical sub-system 9 and the charging terminal 6, a semiconductor fuse HLS can be interconnected between at least one of the two potential lines HV+, HV− between the second onboard electrical sub-system 7 and the changeover switch WS. The semiconductor fuse HS is in particular a unidirectionally blocking semiconductor fuse. With the aid of this semiconductor fuse HLS, the changeover switch WS can be switched load-free. The semiconductor fuse HLS comprises a semiconductor switch 11 and optionally a current capturing unit. This semiconductor switch 11 can be correspondingly switched according to whether the onboard electrical system 3 is in a charging mode of the vehicle battery 2 or in a driving state of the vehicle 1. In the simplest case, the semiconductor fuse can comprise a simple switch element 12 instead of the semiconductor switch 11. In particular if the vehicle battery 2 is charged by means of the charging voltage U_{L}, a switch element 12 of the semiconductor fuse HLS can be closed. Instead or additionally, the semiconductor fuse HLS further comprises at least one diode D. It is in particular connected in parallel with the switch element 12. The diode D can in particular be a body diode, in particular a MOSFET body diode, of the semiconductor switch 11 of the semiconductor fuse HLS. In particular, the diode D has a reversing direction, such that a current flow from the changeover switch WS towards the second onboard electrical sub-system 7 can be inhibited or prevented. Thus, in particular in case of a short circuit, a short circuit current cannot flow into the first onboard electrical sub-system 9. Thus, with the aid of the diode D and/or the switch element 12, a battery current or a charging current of the charging station as the power source 4 can be interrupted in case of a short circuit. Furthermore, the diode D and/or the switch element 12 can be interconnected such that a current can always flow from the first onboard electrical sub-system 9 towards the changeover switch WS. The semiconductor fuse HLS can be unidirectionally blocking, wherein the semiconductor fuse can have a parasitic/undesired behavior. In order to counteract this, the diode D is provided.

In particular, the semiconductor fuse HLS and the changeover switch WS together can form a hybrid switching device 13. With the aid of the hybrid switching device 13, the changeover switch WS can be particularly advantageously switched load-free. As a result, the changeover switch WS does not have to be designed or dimensioned to high currents and/or voltages.

For example, the second onboard electrical sub-system 7 can be referred to as drive onboard electrical system or traction onboard electrical system. The first onboard electrical sub-system 9 can for example be referred to as accessory onboard electrical system.

For example, the second switch element S22 can be formed as a DC charging contactor. The first switch element S21 can be formed as a traction contactor.

In order to be able to particularly efficiently operate the onboard electrical system 3, it can be provided that for the start of the charging process or for the charging mode of the vehicle battery 2, the onboard electrical system 3 is pre-charged before connecting the vehicle battery 2. Thus, the onboard electrical system 3 can be raised to a preset voltage level.

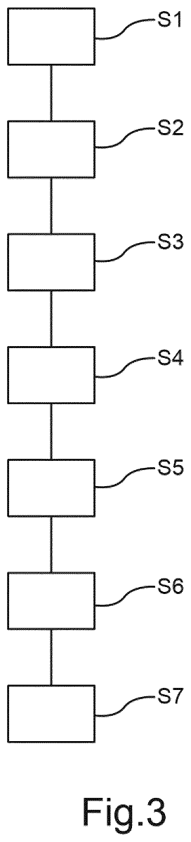

In the following FIG. 3, a schematic flow of a pre-charging process of the onboard electrical system 3 of the vehicle 1 is described. In particular, the pre-charging process is performed immediately, thus directly in time before the charging process of the vehicle battery 2. In particular, the pre-charging process is performed immediately before the following charging process of the vehicle battery 2. Thus, viewed in time, the pre-charging process is affected directly before the charging process is performed. In particular, the charging process of the vehicle battery 2 can be performed only when the pre-charging process of the onboard electrical system 3 has been performed.

In an optional first step S1, the vehicle battery 2, in particular the third onboard electrical sub-system 3, can be galvanically connected to the first onboard electrical sub-system 9 of the onboard electrical system 3 by means of the first switch element S21 and the changeover switch WS. In addition, by means of the second switch element S22, the vehicle battery 2 can be galvanically separated from a charging path 14 (compare FIG. 2), which includes the charging terminal 2. Therein, the second onboard electrical sub-system 9 and the first onboard electrical sub-system 9 can be galvanically separated from the charging path 14 and in particular from the charging terminal 6 by means of the changeover switch WS. Thus, the power source 4 is only connected to the vehicle-side charging terminal 6 and thus to the charging path 14 in this state. In other words, in this first step S1, the initial state for pre-charging the onboard electrical system 3 is explained. During this initial state, an HV onboard electrical system of the vehicle 1 can for example be discharged. Furthermore, in the initial state, in particular during the pre-charging process, the switch element 12 of the semiconductor fuse HLS is opened.

In an optional following second step S2, at least one line capacitance C1 of the charging path 14 of the onboard electrical system 3 can for example be pre-charged to a first voltage value by the power source 4 connected to the charging path 14. In particular, an intermediate circuit of the charging path 14 is pre-charged to the first voltage value in this process.

For example, the pre-charging process of the onboard electrical system 3 can be monitored by an insulation monitoring unit 16 (compare FIG. 2) with respect to an insulating resistance of the onboard electrical system 3 and/or the power source 4. Thus, with the power source connected to the vehicle 1, the insulation strength or insulation stability can be checked or monitored. Therein, it is important that it is checked, which charging standard the charging terminal 6 and the power source 4 are. Therein, the “GB/T standard” can for example be used or be present as the charging standard. If this standard should be present, the insulation of the potential lines HV+, HV− and/or of a charging cable between the vehicle-side charging terminal 6 and the power source 4 can be checked by means of insulation monitoring or the insulation monitoring unit 16 on the one hand. In particular, with the “GB/T standard”, an insulation monitor of the power source 4 is deactivated and the charging process and/or pre-charging process are performed by means of the insulation monitoring unit 16 of the onboard electrical system 3 or of the vehicle 1. For the pre-charging process and charging process, respectively, contactors of the power source 4 on the side of the charging station can be closed.

For example, the second onboard electrical sub-system 7 and the first onboard electrical sub-system 9 can be affected by means of insulation monitoring of the vehicle battery 2.

A further possible charging standard is the “Combined Charging System”. This CCS standard has the effects that the battery insulation monitoring is deactivated during the pre-charging process and/or charging process and these charging processes are performed by means of the insulation monitoring unit 17 of the power source 4.

In a subsequent optional third step S3, at least one capacitor C2 of the first onboard electrical sub-system 9 can be pre-charged to a second voltage value by the vehicle battery 2. Therein, an intermediate circuit of the first onboard electrical sub-system 9 can herein also be pre-charged. Thus, the capacitor C2 is pre-charged to the second voltage value as the target voltage by means of the battery voltage U_{Batt} by means of the connection between the changeover switch WS and the vehicle battery 2. Therein, the at least one capacitor C2 of the first onboard electrical sub-system 9 can be performed by converting the battery voltage U_{Batt} of the vehicle battery 2 by means of a DC voltage converter 15 (compare FIG. 2) of the first onboard electrical sub-system 9. The DC voltage converter 15 can for example be a DC/DC converter.

In particular, the step S2 and step S3 can be performed at the same time, thus parallel. Thus, the pre-charging process of the onboard electrical system 3 can be more efficiently performed. Optionally, the first and/or second voltage value can be set or defined depending on the battery voltage U_{Batt}. In particular, the battery voltage U_{Batt} can have a voltage value of 800 Volts. Therein, the first and/or second voltage value thus can in particular be 800 Volts. In order to be able to employ the semiconductor fuse HS unidirectionally blocking, the second voltage value can have a voltage difference of for example 10 Volts, in particular 20 Volts, advantageously 30 Volts, compared to the first voltage value. Thus, the changeover switch WS can be switched load-free.

In a subsequent optional fourth step S4, it can be examined, which state of charge the two capacitors or capacitances C1, C2 have. Thus, depending on the respective state of charge of the capacitors or capacitances C1, C2, the charging process of the vehicle battery 2 of the vehicle 1 can be performed by means of the power source 4.

In particular, the charging process of the vehicle battery 2 is affected when the line capacitance C1 of the charging path 14 has been charged to the first voltage value and the capacitor C2 of the first onboard electrical sub-system 9 has been charged to the second voltage value. If this is the case, thus, the vehicle battery 2 can be galvanically connected to the charging path 14 by means of the second switch element S22 and galvanically separated from the first onboard electrical sub-system 9 by means of the first switch element S21 and the changeover switch WS for example by a pre-charging switching device of the onboard electrical system 3. Thus, the vehicle battery 2 can be charged by means of the charging voltage U_{L}. Here, a switching operation of the changeover switch WS is thus effected, in particular load-free, such that the vehicle battery 2 can be charged by means of the charging voltage U_{L} on the one hand and the electric components 10 of the second onboard electrical sub-system 9 are also supplied by means of the charging voltage U_{L} from the power source 4.

In an optional additional or parallel step S5, during switching to the charging process of the vehicle battery 2, the second onboard electrical sub-system 7, in particular the electric drive unit 5, can be discharged. Here, an absence of voltage can thus be established.

In an additional optional sixth step S6, for the final charging mode or charging process of the vehicle battery 2, the switch element 12 of the semiconductor fuse HLS can be additionally closed. This can affect a final voltage adaptation of the second onboard electrical sub-system 9 to the voltage level of the power source 4.

In a conclusive optional seventh step S7, the vehicle battery 2 can now be charged by means of the power source 4 on the one hand and the electric components 10 of the first onboard electrical sub-system 9 can be supplied in the meantime. Parallel thereto, the second onboard electrical sub-system 7 and in particular the electric components of the electric powertrain are voltage-free.

1. A method for performing a pre-charging process of an onboard electrical system of a vehicle and for a charging process of a vehicle battery of the vehicle immediately following the pre-charging process,
wherein the vehicle battery is galvanically connected to a first onboard electrical sub-system of the onboard electrical system by a first switch element and a changeover switch, the changeover switch being physically separated from the first switch element and galvanically separated from a charging path of the onboard electrical system by a second switch element that is physically separated from the first switch element and from the changeover switch, and wherein the first onboard electrical sub-system is galvanically separated from the charging path by the changeover switch,
wherein at least one line capacitance of the charging path of the onboard electrical system is pre-charged to a first voltage value by a power source electrically connected to the charging path,
wherein at least one capacitor of the first onboard electrical sub-system is pre-charged to a second voltage value by the vehicle battery,
wherein depending on a respective state of charge of the at least one line capacitance of the charging path and of the at least one capacitor of the first onboard electrical sub-system, the vehicle battery of the vehicle is charged by the power source,
wherein for pre-charging the at least one capacitor of the first onboard electrical sub-system, a switch element of a semiconductor fuse, which is interconnected to at least one potential line between the first onboard electrical sub-system and the changeover switch, is opened, and
wherein for supplying the first onboard electrical sub-system with a charging voltage, the switch element of the semiconductor fuse is closed.

2. The method according to claim 1, wherein if the at least one line capacitance of the charging path is charged to the first voltage value and the at least one capacitor of the first onboard electrical sub-system is charged to the second voltage value, the vehicle battery is galvanically connected to the charging path by the second switch element (S22) and galvanically separated from the first onboard electrical sub-system by the first switch element and the changeover switch, whereby the vehicle battery is charged by the power source.

3. The method according to claim 2, wherein the first onboard electrical sub-system is additionally galvanically connected to the charging path by the changeover switch, whereby the first onboard electrical sub-system is supplied by the power source, in particular at least one electric drive of the onboard electrical system is discharged immediately after the pre-charging process.

4. The method according to claim 1, wherein a current flow from the changeover switch to the first onboard electrical sub-system is inhibited by the semiconductor fuse upon a short circuit within the onboard electrical system.

5. The method according to claim 1, wherein the at least one capacitor of the first onboard electrical sub-system is pre-charged to the second voltage value by converting a battery voltage of the vehicle battery by means of a DC voltage converter of the first onboard electrical sub-system.

6. The method according to claim 1, wherein the at least one line capacitance of the charging path and the at least one capacitor of the first onboard electrical sub-system are charged at the same time.

7. The method according to claim 1, wherein during the pre-charging process of the onboard electrical system, an insulation resistance of the onboard electrical system and/or of the power source is monitored by an insulation monitoring unit of power source or by an insulation monitoring unit of the onboard electrical system.

8. The method according to claim 1, wherein the first voltage value and/or the second voltage value are adjusted depending on a battery voltage of the vehicle battery, in particular a voltage value of 800 V is provided by the battery voltage.

9. An onboard electrical system for a vehicle with a first onboard electrical sub-system for electric components of the vehicle different from an electric drive unit, a second onboard electrical sub-system for the electric drive unit of the vehicle, a third onboard electrical sub-system for a vehicle battery of the vehicle, and a charging terminal for connecting the onboard electrical system to a power source external to vehicle, wherein the onboard electrical system is formed for performing a method according to claim 1.
